(19) United States
(12) Patent Application Publication
(10) Pub. No.: US 2004/0187083 A1
(43) Pub. Date: Sep. 23, 2004

(54) System and method for reducing the size of wireless communications

(76) Inventors: Bryan D. Tracey, Richardson, TX (US); Edward F. Calvesbert, Dallas, TX (US); Daniel G. Hernandez, Frisco, TX (US); Mark Watson, Dallas, TX (US)

Correspondence Address: BAKER BOTTS L.L.P., 2001 ROSS AVENUE, SUITE 600, DALLAS, TX, 75201-2980, US

(21) Appl. No.: 10/392,440

(22) Filed: Mar. 18, 2003

(51) Int. Cl. G06F 15/00

(52) U.S. Cl. 715/532

(57) ABSTRACT

A method of wireless communication is provided. The method includes receiving a first request, generating a first compressed request and a first request dictionary based on the first request, and communicating the first compressed request and the first request dictionary via a wireless link toward an application operable to respond to the first request. The method further includes receiving a second request, generating a second compressed request and a second request dictionary based on the second request and the first request dictionary, and communicating the second compressed request and the second request dictionary toward the application via the wireless link.

### TECHNICAL FIELD OF THE INVENTION

This invention relates in general to wireless communications and, more particularly, to a system and method for reducing the size of wireless communications.

### BACKGROUND OF THE INVENTION

As e-mail has become the primary means for humans to communicate with each other over the Internet, Web Services may become the primary means for computer systems to communicate with each other over the Internet. Many experts believe that Web Services may become nearly ubiquitous in computing platforms in the near future.

Web Services were initially designed specifically with high speed networks in mind. The format of both requests and responses for Web Services is typically a rich and verbose XML-based structure. In many cases, the actual size of the unique data being communicated in a request or response is very small compared to the amount of data carried in the overhead of the XML-based structure.

In addition, the use of wireless handheld devices as mobile computing devices is becoming widespread. Web Services offer a logical and reusable means for handheld devices to communicate with server-side computer systems. However, due to the large amount of overhead associated with the Web Services message structure, the use of Web Services over wireless networks is less than ideal. In particular, the large amount of overhead affects both the speed and cost of communications, and increases the potential for failure during transmission.

### SUMMARY OF THE INVENTION

In accordance with the present invention, systems and methods for reducing the size of wireless communications are provided. According to one embodiment, a method of wireless communication is provided. The method includes receiving a first request, generating a first compressed request and a first request dictionary based on the first request, and communicating the first compressed request and the first request dictionary via a wireless link toward an application operable to respond to the first request. The method further includes receiving a second request, generating a second compressed request and a second request dictionary based on the second request and the first request dictionary, and communicating the second compressed request and the second request dictionary toward the application via the wireless link.

According to another embodiment, another method of wireless communication is provided. The method includes receiving from a requesting entity via a wireless link a first compressed request and a first request dictionary. The first compressed request includes a compressed form of a first request. The method further includes constructing the first request based on the first compressed request and the first request dictionary, and communicating the constructed first request toward an application operable to respond to the first request. The method further includes receiving from the requesting entity via a wireless link a second compressed request and a second request dictionary. The second compressed request includes a compressed form of a second request. The method further includes constructing the second request based on the second compressed request, the first request dictionary and the second request dictionary, and communicating the constructed first request toward the application.

Various embodiments of the present invention may benefit from numerous advantages. It should be noted that one or more embodiments may benefit from some, none, or all of the advantages discussed below.

One advantage of the invention is that the amount of data communicated over a wireless network may be decreased by compressing communications such as requests and responses. This may result in increased speed and reduced cost of communications, and may also reduce the chance of failure during transmission or otherwise increase the quality of the data transmission.

Another advantage of the invention is that the compression dictionaries can be cached on both the client and server side. As such, the dictionaries need not be redundantly resent at each transaction. This allows the system to increasingly optimize transmission sizes over time and adapt quickly to the introduction of new web services. This avoids the need for pre-registering specific web services and storing the WSDL files on the client and server.

Yet another advantage of the invention is that the methods or processes for compressing and decompressing (or reconstructing) communications between a client application and a web application may be transparent to both the client application and the web application. Thus, neither the client application nor the web application need be particularly designed or altered in order to benefit from the present invention.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIGS. 1 and 2 illustrate a communication system for reducing the size of wireless communications, including a client proxy and a proxy server operable to compress and reconfigure communications between client applications and web applications in accordance with one embodiment of the present invention;

FIG. 3 illustrates an example set of SOAP code of a first request generated by an example client phone book application in accordance with one embodiment of the present invention;

FIG. 4 illustrates an example first request dictionary based on the example first request shown in FIG. 3;

FIG. 5 illustrates an example first compressed request generated based on first request shown in FIG. 3 and the first request dictionary shown in FIG. 4;

FIG. 6 illustrates an example client dictionary database in accordance with one embodiment of the present invention;

FIG. 7 illustrates an example sever dictionary database in accordance with one embodiment of the present invention; and

FIG. 8 is a flowchart illustrating a method of compressing and reconfiguring communications between a client application and a web application in accordance with one embodiment of the present invention.

### DETAILED DESCRIPTION OF THE DRAWINGS

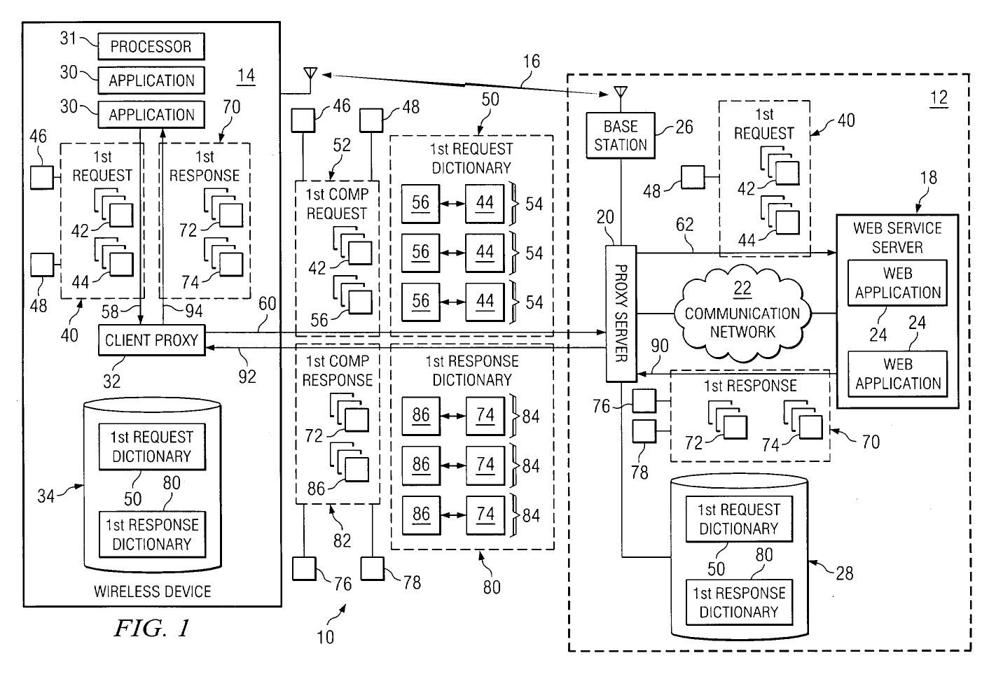

FIG. 1 illustrates a communication system 10 for reducing the size of wireless communications. Communication system 10 comprises a wired network 12 operable to communicate with a wireless device 14 via a wireless link 16. Wired network 12 comprises a web service server 18 and a proxy server 20 coupled to a communications network 22, and a base station 26 coupled to proxy server 20. Communication network 22 is operable to communicate data between web service server 18 and proxy server 20. Communication network 22 may include one or more servers, routers, switches, repeaters, backbones, links and/or any other appropriate type of communication devices coupled by links such as wire line, optical, wireless, or other appropriate links. In general, communication network 22 may include any interconnection found on any communication network, such as a local area network (LAN), metropolitan area network (MAN), wide area network (WAN), the Internet, portions of the Internet, or any other data exchange system created by coupling two or more computers together. Thus, it should be noted that wired network 12 may include one or more wireless links and/or wireless communication devices. It should also be noted that wired network 12 or communication network 22 may include any suitable number of web service servers 18 and proxy servers 20 within the scope of the present invention.

Wireless device 14 is operable to communicate with base station 26 via wireless link 16. Wireless device 14 and base station 26 may communicate using one or more types or protocols of wireless communications, such as using one or more Wireless Application Protocol (WAP) standard protocols, including 802.11, third-generation (3G) protocols (such as W-CDMA or CDMA 2000, for example), or Global System for Mobile Communications (GSM) protocols, for example.

Web service server 18 hosts one or more web applications 24 operable to provide services and/or information to various clients and/or other servers via communication network 22. For example, web applications 24 may include applications such as an on-line phone book or address book application, a transportation or delivery management application, an on-line mapping application, a search engine, or any other type of on-line application or content. Each web application 24 may be operable to communicate various data, such as in the form of an unsolicited communication or a response to a request for services or information, to one or more proxy servers 20 via communications network 22.

Each proxy server 20 is generally operable to compress and decompress (or reconstruct) communications, such as requests and responses, communicated between wireless device 14 and web service server 18. For example, as discussed in greater detail below, proxy server 20 is operable to receive compressed requests from wireless device 14 via wireless link 16 and base station 26, decompress or reconstruct the requests, and communicate the decompressed or reconstructed requests toward the appropriate web application 24. In addition, as discussed in greater detail below, proxy server 20 is operable to receive responses or other communications from web applications 24, compress the responses or other communications, and communicate the compressed responses or other communications toward wireless device 14 via base station 26 and wireless link 16. In order to compress various communications, proxy server 20 may generate any number of dictionaries. In addition, proxy server 20 may receive dictionaries communicated along with the compressed requests received from wireless device 14. Proxy server 20 may store such generated and/or received dictionaries in a server dictionary database 28 coupled to, hosted by, or otherwise associated with proxy server 20.

Each wireless device 14 comprises one or more client applications 30, a processor 31, a client proxy 32, and a client dictionary database 34. Each client application 30 is operable to generate requests for services or other information from one or more web applications 24, and to receive responses from such web applications 24 in response to such requests. For example, client applications 30 may include applications such as a phone book or address book application, a transportation or delivery management application, an mapping application, a search engine application, a warehouse management application, consumer-based applications (such as shopping applications, for example), mobile gaming applications, or any other type of application that benefits from optimized wireless communication between device and server. Processor 31 may be any processor operable to execute computer instructions defined by computer software, and is generally operable to execute client applications 30.

Client proxy 32, like proxy server 20, is generally operable to compress and decompress or reconstruct communications, such as requests and responses, being communicated between applications 30 hosted by wireless device 14 and web applications 24 hosted by web service servers 18. For example, client proxy 32 may be operable to receive requests from client applications 30, compress the requests, and communicate the compressed requests toward the appropriate web applications 24 via wireless link 16. In addition, client proxy 32 is operable to receive compressed communications, such as unsolicited communications and responses to requests, from proxy server 20 via wireless link 16, decompress or reconstruct the compressed communications, and forward the decompressed or reconstructed communications to the appropriate client applications 30.

In order to compress the various requests received from client applications 30, client proxy 32 may generate one or more dictionaries. In addition, client proxy 32 may receive dictionaries communicated along with the compressed communications received from proxy server 20. Client proxy 32 may be operable to store such generated and/or received dictionaries in client dictionary database 34, which may be hosted by or otherwise associated with wireless device 14.

FIG. 1 illustrates an example method or process of communicating a first request and a first response between a client application 30 and a web application 24, in which the first request and first response are compressed and reconstructed by proxy server 20 and client proxy 32. FIG. 2 illustrates an example method or process of communicating a second request and a second response between client application 30 and web application 24 subsequent to the first request and first response, in which the second request and second response are also compressed and reconstructed by proxy server 20 and client proxy 32.

A shown in FIG. 1, client application 30 generates a first request 40 intended for a particular web application 24. First request 40 may comprise a request for a particular web service or information from the web application 24. First request 40 comprises a set of first request data items 42 and a set of first request labels 44. The term “label” as used throughout this document may refer to any label, tag, header, element, or any other type of formatting or packaging information included in a message along with the actual data, or payload, of the message.

Client application 30 (or wireless device 14) may also generate or determine (such as by using an ID database, for example) a client application ID 46 and a web application (or Web Services) ID 48 associated with first request 40. Client application ID 46 identifies the particular client application 30 that generated first request 40, and web application 48 identifies the particular web application 24 for which first request 40 is intended. Client application ID 46 and web application ID 48 may be useful for routing and/or for organizing dictionaries within dictionary databases 28 and 34, for example.

For example, suppose client application 30 is a client phone book application in which a user of wireless device 14 may enter data regarding a target individual into one or more data fields provided by the phone book application 30 (such as a name field, a home phone field, and work phone field, a street address field, a city field, a state field, and a zip code field, for example), submit the entered data to an appropriate phone book web application 24, and receive a response from the web application 24 including various data regarding the target individual.

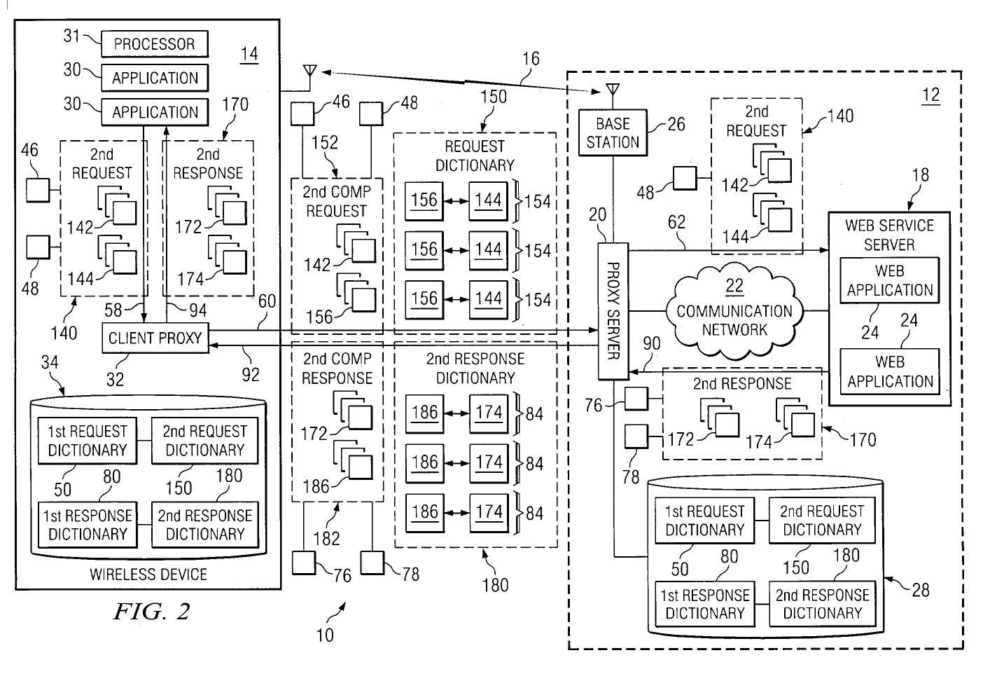

FIG. 3 illustrates an example set of SOAP (Simple Object Access Protocol) code of a first request 40 generated by such a client phone book application 30. In this example, the user of client phone book application 30 entered the name “Bob Smith” and the phone number “555-1234” into a name field and a phone number field of a user interface provided by client phone book application 30, and submitted the entry in order to retrieve the address of Bob Smith from an associated phone book web application 24. The first request 40 shown in FIG. 3 is an example of a SOAP request generated by client phone book application 30 to communicate the entered data, “Bob Smith” and “555-1234,” toward the associated phone book web application 24. As shown in FIG. 3, first request 40 comprises several first request labels 44 and first request data items 42. In particular, first request labels 44 comprise SOAP headers, such as the headers “Name” and “Phone,” and first request data items 42 comprise the data items “Bob Smith” and “555-1234.”

It should be understood that although the example discussed herein focuses on requests and responses generated according to the SOAP protocol, some or all of the systems and methods discussed herein may be similarly applicable for various other communication protocols, such as Hypertext Markup Language (HTML), Extensible Markup Language (XML), Universal Description, Discovery, and Integration (UDDI), or any other suitable protocol without departing from the scope of the present invention.

Returning to FIG. 1, after being generated by client application 30, first request 40, client application ID 46 and web application ID 48 are communicated to, or intercepted by, client proxy 32 via path 58. Client proxy 32 compresses first request 40 before first request 40 is communicated via wireless link 16. In order to compress first request 40, client proxy 32 generates a first request dictionary 50 and a first compressed request 52 based on first request 40. First request dictionary 50 comprises one or more first request dictionary entries 54 generated by client proxy 32. Each first request dictionary entry 54 establishes an association, or correlation, between one of the first request labels 44 contained in first request 40 and a first request key 56. In some embodiments, first request keys 56 are short or simple identifiers, such as short codes, letters or integers, for example, which may be substituted for first request labels 44 (which are generally longer than first request keys 56) in first compressed request 52 and/or subsequent compressed requests, as discussed below.

In an example embodiment, first request keys 56 are integers 1, 2, 3, and so on. Thus, in the example shown in FIG. 3, first request dictionary 50 may comprise one first request dictionary entry 54 assigning a first request key 56 of “1” with a first SOAP header in first request 40, a first request key 56 of “2” with a second SOAP header in first request 40, a first request key 56 of “3” with a third SOAP header in first request 40, and so on. In a particular embodiment, a unique first request key 56 is assigned only to each unique first request label 44 contained in first request 40. Thus, for example, if a particular SOAP header were included multiple times within first request 40, only one first request key 56 would be assigned to that SOAP header, rather than a unique first request key 56 being assigned to each instance of the SOAP header.

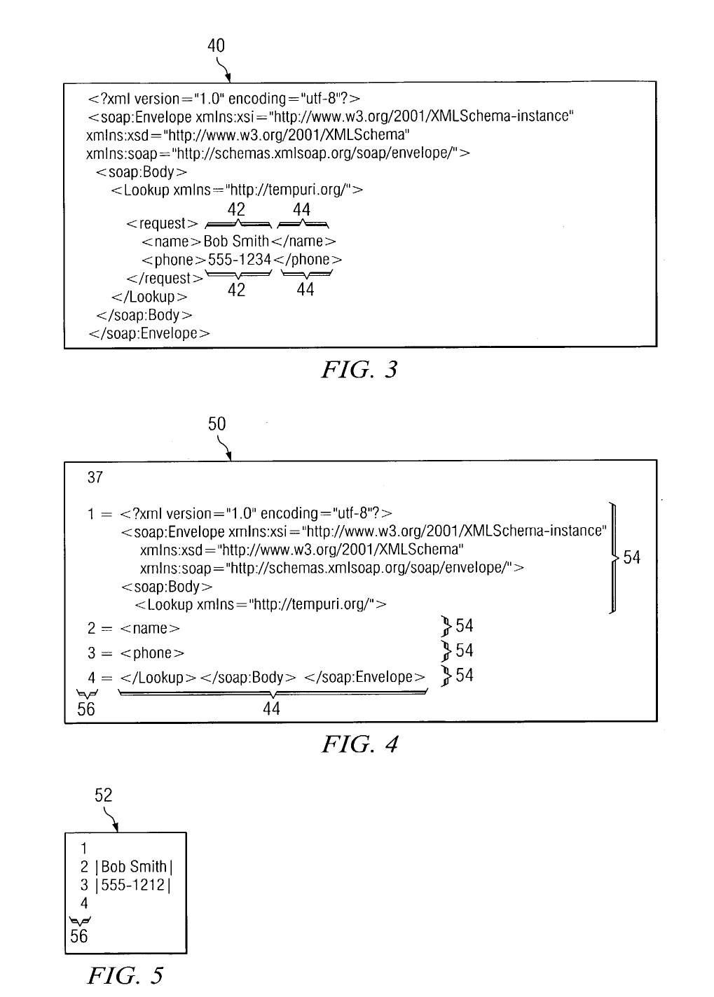

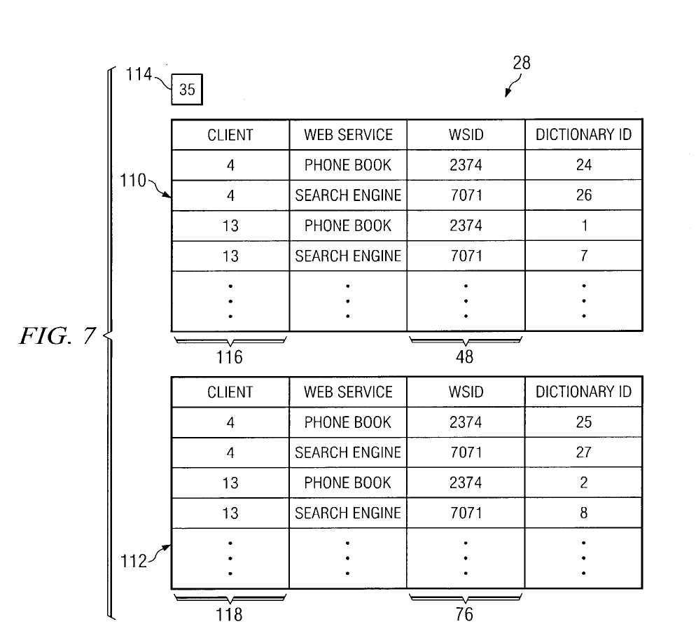

FIG. 4 illustrates an example first request dictionary 50 based on the example first SOAP request 40 shown in FIG. 3 and discussed above. First request dictionary 50 comprises four first request dictionary entries 54, each establishing an association between one of the first request labels 44 (in this example, SOAP headers) contained in first request 40 and a first request key 56 (in this example, integers 1, 2, 3 and 4). Client proxy 32 may store first request dictionary 50 in client dictionary database 34 for future reference. In some embodiments, client proxy 32 stores first request dictionary 50 in client dictionary database 34 according to client application ID 46 and/or web application ID 48 associated with first request 40. For example, as discussed below with reference to FIG. 6, client dictionary database 34 may include one or more request dictionaries 50 for each client application 30 hosted by wireless device 14, and client application ID 46 may be used for organizing first request dictionary 50 within client dictionary database 34.

Client proxy 32 may generate first compressed request 52 according to the generated first request dictionary 50. For example, client proxy 32 may substitute, for each first request label 44 (in this example, each SOAP header) contained in first request 40, the associated first request key 56, according to the associations defined by first request dictionary 50. Thus, in the example discussed above, client proxy 32 may substitute the integers 1, 2, 3 and 4 for their corresponding SOAP headers as defined by first request dictionary 50.

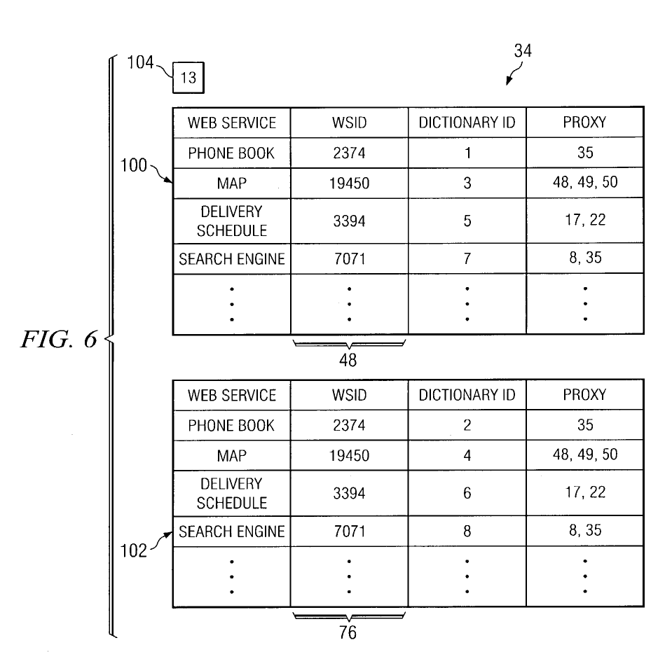

FIG. 5 illustrates an example first compressed request 52 generated based on first request 40 and first request dictionary 50. It can be seen that first compressed request 52 may thus comprise the set of data items 42 contained within first request 40, as well as the set of first request keys 56 substituted for the respective corresponding first request labels, or SOAP headers, 42.

In some embodiments, first compressed request 52—including first request data items 42 and first request keys 56—may be further compressed before being communicated toward the phone book web application 24. For example, first compressed request 52 may be further compressed using a ZIP™ compression algorithm, or any other suitable compression algorithm or method.

Returning to FIG. 1, first request dictionary 50, first compressed request 52, client application ID 46 and web application ID 48 may be communicated toward the phone book web application 24 along path 60 via wireless link 16. First request dictionary 50 and first compressed request 52 may be received by base station 26 and forwarded to, or intercepted by, proxy server 20. Proxy server 20 decompresses first compressed request 52, or in other words, reconstructs first request 40, based on first compressed request 52 and first request dictionary 50. In some embodiments, proxy server 20 decompresses first compressed request 52 (or reconstruct first request 40) using a similar process as that used by client 32 to generate first compressed request 52, but in reverse. For example, proxy server 20 may replace each first request key 56 in first compressed request 52 with its associated first request label 44, as defined by first request dictionary 50. Thus, in the example discussed above, proxy server 20 may replace each first request key 56, namely first request keys “1”, “2”, “3” and “4” with their associated SOAP headers as defined by first request dictionary 50. In this manner, proxy server 20 may reconstruct the first request 40 generated by client phone book application 30.

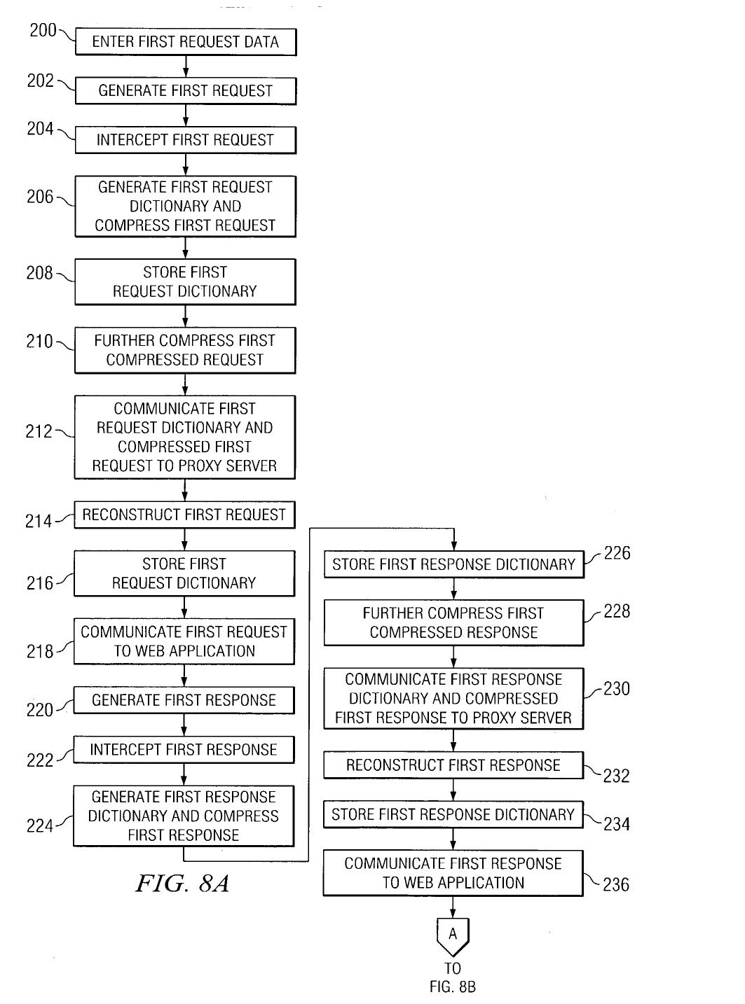

As shown in FIG. 1, proxy server 20 may communicate the reconstructed first request 40 along path 62 via communications network 22 toward the web service server 18 hosting the appropriate phone book web application 24. In addition, proxy server 20 may store first request dictionary 50 in server dictionary database 28 for future reference. In some embodiments, proxy server 20 stores first request dictionary 50 in server dictionary database 28 according to client application ID 46 and/or web application ID 48 associated with first request 40. For example, as discussed below with reference to FIG. 7, client dictionary database 34 may include, for each of a plurality of clients of wireless devices 14, request dictionaries 50 for one or more web applications 24 with which that wireless device 14 has communicated, and client application ID 46 and web application ID 48 may be used for organizing first request dictionary 50 within client dictionary database 34.

The process of compressing and decompressing first request 40 may thus remain transparent to both client phone book application 30 and phone book web application 24.

The web service server 18 hosting the phone book web application 24 may receive and forward first request 40 to phone book web application 24. Phone book web application 24 may process first request 40 and generate a first response 70. For example, phone book web application 24 may locate data regarding the individual named Bob Smith having the phone number 555-1234 from a phone book database. Phone book web application 24 may then generate a first response 70 that includes the address of Bob Smith. For example, first response 70 may be a SOAP response including a set of first response data items 72 and a set of first response labels 74. Data items 72 may include, for example, “1054 Main St.,” “Albuquerque,” “N. Mex.,” and “63257.” First response labels 74 may comprise SOAP headers similar to first request labels 44. For example, first response labels 74 may include SOAP headers such as “Street Address,” “City,” “State,” and “Zip Code.”

Web application 24 (or web service server 18) may also generate a web application (or Web Services) ID 76 and a client application ID 78 associated with first response 70. Web application ID 76 identifies the particular web application 24 that generated first response 70, and client application ID 46 identifies the particular wireless device 14 and client application 30 for which first response 70 is intended. Web application ID 76 and client application ID 78 may be useful for routing and/or for organizing dictionaries within dictionary databases 28 and 34, for example.

As shown in FIG. 1, first response 70, web application ID 76 and client application ID 78 are communicated along path 90 via communications network 22 toward the wireless device 14. First response 70 is received, or intercepted, by proxy server 20, which compresses first response 70 before first response 70 is communicated via wireless link 16. In order to compress first response 70, proxy server 20 generates a first response dictionary 80 and a first compressed response 82 based on first response 70. First response dictionary 80 comprises one or more first response dictionary entries 84 generated by proxy server 20. Similar to first request dictionary entries 54, each first response dictionary entry 84 establishes an association, or correlation, between one of the first response labels 74 contained in first response 70 and a first response key 86. In some embodiments, first response keys 86 are short or simple identifiers, such as short codes, letters or integers, for example, which may be substituted for first response labels 74 (which are generally longer than first request keys 86) in first compressed response 82 and/or subsequent compressed responses, as discussed below.

In the example embodiment discussed above, first response keys 86, like first request keys 54, are integers 1, 2, 3, and so on. Thus, first response dictionary 80 may comprise one first response dictionary entry 84 assigning a first response key 86 of “1” with a first SOAP header in first response 70, a first response key 86 of “2” with a second SOAP header in first response 70, a first response key 86 of “3” with a third SOAP header in first response 70, and so on. In a particular embodiment, a unique first response key 86 is assigned only to each unique first response label 74 contained in first response 70. Thus, for example, if a particular SOAP header were included multiple times within first response 70, only one first response key 86 would be assigned to that SOAP header, rather than a unique first response key 86 being assigned to each instance of the SOAP header.

Thus, first response dictionary 80 may have a similar format to that of first request dictionary 50 shown in FIG. 3 and discussed above. For example, suppose first response 70 comprises six first response labels, or SOAP headers, 72. First response dictionary 80 may comprise six first response dictionary entries 84, each establishing an association between one of the six first response labels, or SOAP headers, 72 and a first response key 86 (in this example, integers 1 through 6). However, in some embodiments or situations, there need not be one-to-one correspondence between labels 72 and keys 86. For example, in some embodiments, a particular key 86 may be assigned to more than one label 72, and vice versa.

Proxy server 20 may then generate first compressed response 82 according to the generated first response dictionary 80. For example, proxy sever 20 may substitute, for each first response label 74 (in this example, each SOAP header) contained in first response 70, the associated first response key 86, according to the associations defined by first response dictionary 80. Thus, in the example discussed above, proxy server 20 may substitute the integers 1, 2, 3, 4, 5 and 6 for their corresponding SOAP headers as defined by first response dictionary 80. First compressed response 82 may thus comprise the set of data items 72 contained within first response 70, as well as the set of first response keys 86 substituted for the respective corresponding first response labels, or SOAP headers, 72.

In some embodiments, first compressed response 82—including first response data items 72 and first response keys 86—may be further compressed before being communicated toward wireless device 14. For example, first compressed response 82 may be further compressed using a ZIP™ compression algorithm, or any other suitable compression algorithm or method.

In addition, proxy server 20 may store first response dictionary 80 in server dictionary database 28 for future reference. In some embodiments, proxy server 20 stores first response dictionary 80 in server dictionary database 28 according to web application ID 76 and/or client application ID 78 associated with first response 70. For example, as discussed below with reference to FIG. 7, server dictionary database 28 may include, for each of a plurality of clients of wireless devices 14, response dictionaries 80 for one or more web applications 24 with which that wireless device 14 has communicated, and web application ID 76 and client application ID 78 may be used for organizing first response dictionary 80 within server dictionary database 28.

As shown in FIG. 1, first response dictionary 80, first compressed response 82, web application ID 76 and client application ID 78 may be communicated toward wireless device 14 via base station 26 and wireless link 16, along path 92. First response dictionary 80 and first compressed response 82 may be received by wireless device 14 via wireless link 16. First response dictionary 80 and first compressed response 82 may then be forwarded to, or intercepted by, client proxy 32 before being received by client phone book application 30. Client proxy 32 may decompress first compressed response 82, or in other words, reconstruct first response 70, based on first compressed response 82 and first response dictionary 80. In some embodiments, client proxy 32 decompresses first compressed response 82 (or reconstruct first response 70) using a similar process as that used by client 32 to generate first compressed response 82, but in reverse. Thus, in some embodiments, client proxy 32 decompresses first compressed response 82 using a process similar to that used by proxy server 20 to decompress first compressed request 52.

For example, client proxy 32 may replace each first response key 86 in first compressed response 82 with its associated first response label 74, as defined by first response dictionary 80. Thus, in the example discussed above, client proxy 32 may replace each first response key 86, namely first response keys “1”, “2”, “3”, “4”, “5” and “6” with their associated SOAP headers as defined by first response dictionary 80. In this manner, client proxy 32 may reconstruct the first response 70 generated by client phone book application 30.

As shown in FIG. 1, client proxy 32 may then communicate the reconstructed first response 70 along path 94 toward client phone book application 30. Client phone book application 30 may receive first response 70 and, in some embodiments, display or otherwise present one or more of the first response data items 72 to the user of wireless device 14. In addition, client proxy 32 may store first response dictionary 80 in client dictionary database 34 for future reference. In some embodiments, client proxy 32 stores first response dictionary 80 in client dictionary database 34 according to web application ID 76 and/or client application ID 78 associated with first request 40.

Thus, in some embodiments, the process of compressing and decompressing first response 70 may also remain transparent to both client phone book application 30 and phone book web application 24.

As discussed above, FIG. 2 illustrates an example method or process of communicating a second request 140 and a second response 170 between a client application 30 and a web application 24 subsequent to the communication of first request 40 and first response 70 described above. Like first request 40 and first response 70, second request 140 and second response 170 are compressed and reconstructed by proxy server 20 and client proxy 32.

As shown in FIG. 2, client phone book application 30 generates second request 140 intended for the same phone book web application 24 as first request 40. Second request 140 may comprise a request for more information regarding Bob Smith, or a request for information regarding another individual, for example. Like first request 40, second request 140 comprises a set of second request data items 142 and a set of second request labels 144. Client phone book application 30 (or wireless device 14) may determine (such as by using an ID database, for example) client application ID 46 and web application (or Web Services) ID 48 associated with second request 140.

For example, suppose the user of wireless device 14 wishes to obtain data regarding another individual, Mary Brown, based on the name Mary Brown and the street address 4008 Wilshire Street. The user may enter “Mary Brown” and the “4008 Wilshire Street” into a name field and a street address field of a user interface provided by client phone book application 30, and submit the entry in order to retrieve the home phone number of Mary Brown from phone book web application 24. Second request 140 may be a SOAP request including one or more second request labels 144 and one or more second request data items 142. In particular, second request labels 144 comprise SOAP headers, such as the headers “Name” and “Street Address,” and second request data items 142 comprise the data items “Mary Brown” and “4008 Wilshire Street.”

After being generated by client application 30, second request 140, client application ID 46 and web application ID 48 are communicated to, or intercepted by, client proxy 32 via path 58. Client proxy 32 compresses second request 140, including generating a second request dictionary 150 and a second compressed request 152 based on second request 140. Like first request dictionary 50, second request dictionary 150 comprises one or more second request dictionary entries 154 generated by client proxy 32. Each second request dictionary entry 154 establishes an association, or correlation, between one of the second request labels 144 contained in second request 140 and a second request key 156. Second request keys 156 may have a similar format as first request keys 56. However, second request keys 156 may be unique from first request keys 56. In particular embodiments, second request keys 156 may continue in a series defined by first request keys 56. For example, in the example discussed above, since first request keys 56 comprise the integers “1”, “2”, “3” and “4,” second request keys 156 may comprise the integers “5”, “6”, “7”, and so on. Thus, second request dictionary 150 may comprise one second request dictionary entry 154 assigning a second request key 156 of “5” with a first SOAP header in second request 140, a second request key 156 of “6” with a second SOAP header in second request 140, a second request key 156 of “7” with a third SOAP header in second request 140, and so on.

In a particular embodiment, a unique second request key 156 is assigned only to each unique second request label 144 contained in second request 140. Thus, for example, if a particular SOAP header were included multiple times within second request 140, only one second request key 156 would be assigned to that SOAP header, rather than a unique second request key 156 being assigned to each instance of the SOAP header.

In some embodiments, second request dictionary 150 is generated by client proxy 32 based on both second request 140 and first request dictionary 50. For example, in one embodiment, for each unique second request label 144 contained in second request 140, client proxy 32 determines whether that second request label 144 is included within first request dictionary 50 (in other words, whether the second request label 144 is the same label as any first request label 44 included in first request dictionary 50). Client proxy 32 may then generate a second request dictionary entry 154 assigning a unique second request key 56 to the second request label 144 if it is determined that the second request label 144 is not included within first request dictionary 50. Alternatively, client proxy 32 may not generate a second request dictionary entry 154 for the second request label 144 if it is determined that the second request label 144 is included within first request dictionary 50. Thus, in the example discussed above, for the second request label 144 “Street Address,” client proxy 32 would determine that the label “Street Address” is not included within first request dictionary 50 (as shown in FIG. 4), and thus would generate a second request dictionary entry 154 assigning a unique second request key 56 to the second request label 144. However, for the second request label 144 “Name,” client proxy 32 would determine that the label “Name” is included within first request dictionary 50 (as shown in FIG. 4), and thus would not generate a second request dictionary entry 154 for second request label 144.

In an alternative embodiment, for each unique second request label 144 contained in second request 140, client proxy 32 generates a second request dictionary entry 154 for each unique second request label 144, and then determines whether to exclude any of such generated second request dictionary entries 154 from second request dictionary 150. For example, after generating a second request dictionary entry 154 for each unique second request label 144, client proxy 32 may determine, for each second request label 144, whether that second request label 144 is included within first request dictionary 50 (in other words, whether the second request label 144 is the same label as any first request label 44 included in first request dictionary 50). Client proxy 32 may then exclude from the second request dictionary 150 the relevant second request dictionary entry 154 for each second request label 144 determined to be included in first request dictionary 50. Thus, in the example discussed above, client proxy 32 may generate a second request dictionary entry 154 for each unique second request label 144 (including “Name,” “Street Address,” “City,” “State,” and “Zip Code,” for example), but then exclude the second request dictionary entry 154 generated for the second request label 144 of “Name,” since the label “Name” is included in first request dictionary 50 (as shown in FIG. 4).

In addition, client proxy 32 may store second request dictionary 150 in client dictionary database 34 for future reference. In some embodiments, client proxy 32 stores second request dictionary 150 in client dictionary database 34 according to client application ID 46 and/or web application ID 48 associated with second request 140. Second request dictionary 150 may be combined with, or stored separately from, first request dictionary 50, as discussed below with reference to FIG. 6.

Is this manner, client proxy 32 may generate and store a second request dictionary 140 that includes labels not included in first request dictionary 50. In some embodiments, client proxy 32 may similarly generate request dictionaries for subsequent requests from client application 30 that include labels not included in any request dictionary previously generated or stored in client dictionary database 34 for the particular client application 30. Thus, in the example discussed above, client proxy 32 may generate a third request dictionary for a subsequent third request from client phone book application 30 that includes labels not included in first request dictionary 50 or second request dictionary 150.

Returning to FIG. 2, after generating second request dictionary 150, client proxy 32 may generate second compressed request 152 according to second request dictionary 150. For example, client proxy 32 may substitute, for each second request label 144 contained in second request 140, the associated second request key 156, according to the associations defined by second request dictionary 150 and/or first request dictionary 150. Thus, in the example discussed above, client proxy 32 may replace the SOAP headers “Street Address,” “City,” “State,” and “Zip Code” with the corresponding second request key 156 as defined by second request dictionary 150, and may replace the SOAP header “Name” with the corresponding first request key 156 as defined by first request dictionary 50.

In some embodiments, second compressed request 152—including second request data items 142 and second request keys 156—may be further compressed before being communicated toward phone book web application 24, such as using a ZIP™ or other suitable compression technique, as discussed above with reference to first compressed request 52.

As shown in FIG. 2, second request dictionary 150, second compressed request 152, client application ID 46 and web application ID 48 may be communicated toward phone book web application 24 along path 60 via wireless link 16. Second request dictionary 150 and second compressed request 152 may be received by base station 26 and forwarded to, or intercepted by, proxy server 20. Proxy server 20 decompresses second compressed request 152 (or in other words, reconstructs second request 140) based on second compressed request 152, second request dictionary 150 and/or first request dictionary 50. For example, proxy server 20 may replace each first request key 56 and/or second request key 156 in second compressed request 152 with the associated first and/or second request labels 44 and 144, as defined by first and second request dictionaries 50 and 150. In this manner, proxy server 20 may reconstruct second request 140.

As shown in FIG. 2, proxy server 20 may communicate reconstructed second request 140 along path 62 via communications network 22 toward phone book web application 24. In addition, proxy server 20 may store second request dictionary 150 in server dictionary database 28 for future reference. In some embodiments, proxy server 20 stores second request dictionary 150 in server dictionary database 28 according to client application ID 46 and/or web application ID 48 associated with second request 140. Second request dictionary 150 may be combined with, or stored separately from, first request dictionary 50, as discussed below with reference to FIG. 7.

The process of compressing and decompressing second request 140 may thus remain transparent to both client phone book application 30 and phone book web application 24.

The web service server 18 hosting the phone book web application 24 may receive and forward second request 140 to phone book web application 24. Phone book web application 24 may process second request 140 and generate a second response 170. For example, phone book web application 24 may locate the home phone number for Mary Brown from a phone book database. Web application 24 may then generate a second response 170 that includes the home phone number of Mary Brown. For example, second response 170 may be a SOAP response including a set of second response data items 172 and a set of second response labels 174. Data items 172 may include, for example, a data item “927-4343.” Second response labels 174 may comprise, for example, a SOAP header “Home Phone.” Web application 24 (or web service server 18) may also determine web application (or Web Services) ID 76 and client application ID 78 associated with second response 170.

As shown in FIG. 2, second response 170, web application ID 76 and client application ID 78 are communicated along path 90 via communications network 22 toward the wireless device 14. Second response 170 is received, or intercepted, by proxy server 20, which compresses second response 170 before second response 170 is communicated via wireless link 16. In order to compress second response 170, proxy server 20 generates a second response dictionary 180 and a second compressed response 182 based on both second response 170 and first response dictionary 80. In some embodiments, proxy server 20 may generate second response dictionary 180 using one or more of the various methods or processes discussed above regarding the generation of first response dictionary 150 by client server 32. Proxy server 20 may store second response dictionary 180 in server dictionary database 28 for future reference. In some embodiments, proxy server 32 stores second response dictionary 180 in server dictionary database 28 according to web application ID 76 and/or client application ID 78 associated with second response 170. Second response dictionary 180 may be combined with, or stored separately from, first response dictionary 80, as discussed below with reference to FIG. 7.

Is this manner, proxy server 20 may generate and store a second response dictionary 140 that includes labels not included in first response dictionary 80. In some embodiments, proxy server 20 may similarly generate response dictionaries for subsequent responses from phone book web application 24 that include labels not included in any response dictionary previously generated or stored in server dictionary database 28 for the particular client application 30. Thus, in the example discussed above, proxy server 20 may generate a third response dictionary for a subsequent third response from phone book web application 24 that includes labels not included in first response dictionary 80 or second response dictionary 180.

Second response dictionary 180 may have a similar format to that of first request dictionary 80, discussed above. For example, suppose second response 170 comprises four second response labels, or SOAP headers, 172. Second response dictionary 180 may comprise four second response dictionary entries 184, each establishing an association between one of the four second response labels, or SOAP headers, 172 and a second response key 186. In this example, since first response keys 86 include integers 1 though 6, as discussed above, the four second response keys 186 may include integers 7 through 10.

Proxy server 20 may then generate second compressed response 182 according to the generated second response dictionary 180 and/or first response dictionary 80. For example, proxy sever 20 may substitute, for each first and/or second response label 74 and 172 contained in second response 170, the associated first or second response key 86 or 186, according to the associations defined by first and second response dictionaries 80 and 180. Second compressed response 182 may thus comprise the set of data items 172 contained within second response 170, as well as the first and/or second response keys 86 and 186 substituted for the respective corresponding first response labels 174 contained within second response 170.

In some embodiments, second compressed response 182—including second response data items 172 and second response keys 186—may be further compressed before being communicated toward wireless device 14, such as using a ZIP™ or other suitable compression technique, as discussed above with reference to first compressed response 82.

As shown in FIG. 2, second response dictionary 180, second compressed response 182, web application ID 76 and client application ID 78 may be communicated toward wireless device 14 via base station 26 and wireless link 16, along path 92. Second response dictionary 180 and second compressed response 182 may be received by wireless device 14 via wireless link 16. Second response dictionary 180 and second compressed response 182 may then be forward to, or intercepted by, client proxy 32 before being received by client phone book application 30. Client proxy 32 may decompress second compressed response 182 (or in other words, reconstruct second response 170) based on second compressed response 182, second response dictionary 180 and/or first response dictionary 80. For example, client proxy 32 may replace each first response key 86 and/or second response key 186 in second compressed response 182 with the associated first and/or second response labels 74 and 174, as defined by first and second response dictionaries 80 and 180. In this manner, client proxy 32 may reconstruct second response 170.

As shown in FIG. 2, client proxy 32 may then communicate the reconstructed second response 170 along path 94 toward client phone book application 30. Client phone book application 30 may receive second response 170 and, in some embodiments, display or otherwise present one or more of the second response data items 172 to the user of wireless device 14.

In addition, client proxy 32 may store second response dictionary 180 in client dictionary database 34 for future reference. In some embodiments, client proxy 32 stores second response dictionary 180 in client dictionary database 34 according to web application ID 76 and/or client application ID 78 associated with second response 170. Second response dictionary 180 may be combined with, or stored separately from, first response dictionary 80, as discussed below with reference to FIG. 6.

Thus, in some embodiments, the process of compressing and decompressing second response 170 may also remain transparent to both client phone book application 30 and phone book web application 24.

FIG. 6 illustrates an example client dictionary database 34. Client dictionary database 34 may include a request dictionary portion 100 and a response dictionary portion 102. Client dictionary database 34 may also include a client identifier 104 identifying the wireless device 14 upon which client dictionary database 34 is hosted or otherwise associated. In this example, the particular client or wireless device 14 is identified as client “13.”

Request dictionary portion 100 comprises one or more dictionaries generated by client proxy 32 for requests made by various client applications 30 for web services or other services, such as first and second request dictionaries 50 and 150, for example. In the embodiment shown in FIG. 6, request dictionary portion 100 includes a request dictionary for each of a number of web services, or web applications 24. For each dictionary, request dictionary portion 100 includes the name of the relevant web service or web application 24, the Web Service or web application ID (WSID) 48 for that web application 24, a dictionary ID for the dictionary, and a listing of one or more proxy servers 20 associated with the web service or web application 24. In this embodiment, the various dictionaries generated by a client proxy 32 for a particular web application 24 are combined into a single, building dictionary. Thus, in the example discussed above, first request dictionary 50 is stored as dictionary number 1, and second request dictionary 150 is combined with, or added to, dictionary number 1. Additional request dictionaries (such as a third request dictionary, a fourth request dictionary, and so on) generated by client proxy 32 for phone book web application 24 are similarly combined with, or added to, dictionary number 1. Thus, each dictionary in request dictionary portion 100 may be dynamic or growing.

Response dictionary portion 102 comprises one or more response dictionaries generated by various proxy servers 20 and received by client proxy 32. The response dictionaries were generated by the various proxy servers 20 for responses generated by various web applications 24, such as response dictionaries 80 and 180 generated by proxy server 20, for example. In the embodiment shown in FIG. 6, response dictionary portion 102 includes a response dictionary for each of a number of web services, or web applications 24. For each response dictionary, response dictionary portion 102 includes the name of the relevant web service or web application 24, the Web Service or web application ID (WSID) 76 for that web application 24, a dictionary ID for the dictionary, and a listing of one or more proxy servers 20 associated with the web service or web application 24. In this embodiment, the various dictionaries generated by a particular proxy server 20 for a particular web application 24 are combined into a single, building dictionary. Thus, in the example discussed above, first response dictionary 80 is stored as dictionary number 2, and second response dictionary 180 is combined with, or added to, dictionary number 2. Additional response dictionaries (such as a third response dictionary, a fourth response dictionary, and so on) generated by proxy server 20 for phone book web application 24 and received by client proxy 32 are similarly combined with, or added to, dictionary number 2. Thus, each dictionary in response dictionary portion 102 may be dynamic or growing.

FIG. 7 illustrates an example sever dictionary database 28. Server dictionary database 28 may include a request dictionary portion 110 and a response dictionary portion 112. Server dictionary database 28 may also include a proxy server identifier 114 identifying the particular proxy server 20 with which server dictionary database 28 is associated. In this example, the particular proxy server 20 is identified as proxy server “32.” As shown in FIG. 6, proxy server “32” services at least the “phone book” and “search engine” web services or applications 24.

Request dictionary portion 110 comprises one or more request dictionaries generated by client proxy 32 and received by proxy server 20. The request dictionaries are generated by client proxies 32 hosted by various clients or wireless devices 14 for various client applications 30 hosted by such clients or wireless devices 14, such as first and second request dictionaries 50 and 150 for client phone book application 30 discussed above, for example. In the embodiment shown in FIG. 7, request dictionary portion 110 includes a request dictionary for each of a number of web applications 24 associated with the particular proxy server 20, for each of one or more clients or wireless devices 14. Thus, as shown in FIG. 7, request dictionary portion 110 comprises a request dictionary for two web applications 24 associated with proxy server number “35”—namely, phone book and search engine web applications 24—for at least clients “4” and “13” (note that the client dictionary database for client 13 is shown in FIG. 6).

For each request dictionary, request dictionary portion 110 includes a client or wireless device 14 identifier 116 (which may be associated with or determined from the relevant client application ID 46), the relevant Web Service or web application 24, the Web Service or web application ID (WSID) 48 for that web application 24, and a dictionary ID for the request dictionary. In this embodiment, the various request dictionaries generated by proxy server 20 for each web application 24 for each client or wireless device 14 are combined into a single, building dictionary. Thus, in the example discussed above, first request dictionary 50 is stored as dictionary number 1, and second request dictionary 150 is combined with, or added to, dictionary number 1. Additional request dictionaries (such as a third request dictionary, a fourth request dictionary, and so on) generated by client proxy 32 for phone book web application 24 and received by proxy server 20 are similarly combined with, or added to, dictionary number 1. Thus, each dictionary in request dictionary portion 110 may be dynamic or growing.

Response dictionary portion 112 comprises one or more response dictionaries generated by proxy server 20 for responses generated by each web applications 24 with which that particular proxy server 20 is associated, such as response dictionaries 80 and 180 generated by proxy server 20, for example. In the embodiment shown in FIG. 7, response dictionary portion 112 includes a response dictionary for each of a number of web applications 24 associated with the particular proxy server 20, for each of one or more clients or wireless devices 14. Thus, as shown in FIG. 7, response dictionary portion 112 comprises a response dictionary for two web applications 24 associated with proxy server number “35”—namely, phone book and search engine web applications 24—for at least clients “4” and “13” (note that the client dictionary database for client 13 is shown in FIG. 6).

For each response dictionary, response dictionary portion 112 includes a client or wireless device 14 identifier 118 (which may be associated with or determined from the relevant client application ID 78), the relevant Web Service or web application 24, the Web Service or web application ID (WSID) 76 for that web application 24, and a dictionary ID for the response dictionary. In this embodiment, the various dictionaries generated by proxy server 20 for each web application 24 for each client or wireless device 14 are combined into a single, building dictionary. Thus, in the example discussed above, first response dictionary 80 is stored as dictionary number 2, and second response dictionary 180 is combined with, or added to, dictionary number 2. Additional response dictionaries (such as a third response dictionary, a fourth response dictionary, and so on) generated by proxy server 20 for phone book web application 24 are similarly combined with, or added to, dictionary number 2. Thus, each dictionary in response dictionary portion 112 may be dynamic or growing.

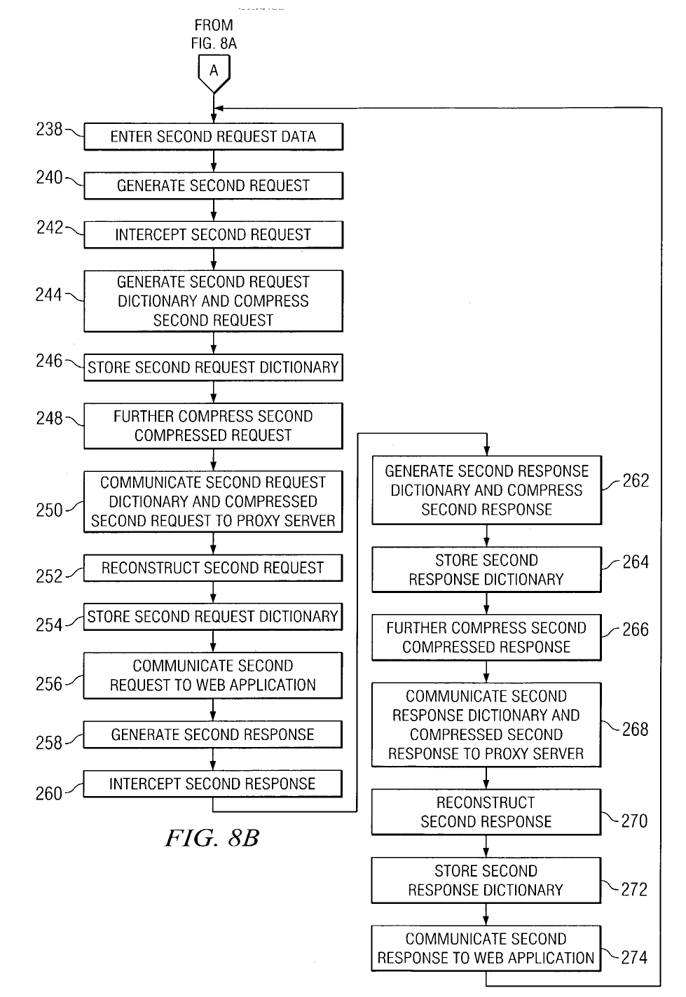

FIG. 8 is a flowchart illustrating an example method of compressing and reconfiguring communications between a client application and a web application in accordance with one embodiment of the present invention. At step 200, a user of wireless device 14 enters first request data into a particular client application 30 hosted by wireless device 14. The first request data comprises data regarding a first request for information or services from a particular web application 24. At step 202, the client application 30 generates a first request 40 intended for the web application 24 based on the first request data entered by the user. Client application 30 also generates or determines a client application ID 46 and a web application ID 48 associated with first request 40.

At step 204, first request 40, client application ID 46 and web application ID 48 are communicated to, or intercepted by, client proxy 32 via path 58. At step 206, client proxy 32 compresses first request 40, including generating a first request dictionary 50 and a first compressed request 52 based on first request 40. At step 208, first request dictionary 50 is stored in client dictionary database 34 for future reference.

At step 210, first compressed request 52 is further compressed, such as using a ZIP™ compression algorithm, for example. At step 212, first request dictionary 50, first compressed request 52, client application ID 46 and web application ID 48 are communicated toward web application 24 along path 60 via wireless link 16. First request dictionary 50 and first compressed request 52 are received by base station 26 and forwarded to, or intercepted by, proxy server 20.

At step 214, proxy server 20 decompresses first compressed request 52 (or in other words, reconstructs first request 40) using first request dictionary 50. At step 216, first request dictionary 50 is stored in server dictionary database 28 for future reference.

At step 218, the reconstructed first request 40 is communicated along path 62 via communications network 22 toward the web service server 18 that hosts the web application 24. The web service server 18 may receive and forward first request 40 to the web application 24. At step 220, web application 24 processes first request 40 and generates a first response 70. Web application 24 also generates a web application ID 76 and a client application ID 78 associated with first response 70.

At step 222, first response 70, web application ID 76 and client application ID 78 are communicated along path 90 via communications network 22 and received, or intercepted, by proxy server 20. At step 224, proxy server 20 compresses first response 70, including generating a first response dictionary 80 and a first compressed response 82 based on first response 70. At step 226, first response dictionary 70 is stored in server dictionary database 28 for future reference.

At step 228, first compressed response 82 is further compressed, such as using a ZIP™ compression algorithm, for example. At step 230, first response dictionary 80, first compressed response 82, web application ID 76 and client application ID 78 are communicated toward wireless device 14 via wireless link 16 along path 92. First response dictionary 80 and first compressed response 82 are received by wireless device 14 and forwarded to, or intercepted by, client proxy 32.

At step 232, client proxy 32 decompresses first compressed response 82 (or in other words, reconstructs first response 70) using first response dictionary 80. At step 234, first response dictionary 80 is stored in client dictionary database 34 for future reference.

At step 236, the reconstructed first response 70 is communicated along path 94 toward client application 30. First response 70 is received by client application 30, which may display or otherwise present at least a portion of first response 70 to the user of wireless device 14.

At step 238, the user of wireless device 14 enters second request data into client application 30 regarding a second request for data from web application 24. At step 240, client application 30 generates a second request 140 intended for web application 24 based on the second request data entered by the user. Client application 30 also determines client application 46 and web application ID 48 associated with second request 140.

At step 242, second request 140, client application ID 46 and web application ID 48 are communicated to, or intercepted by, client proxy 32 via path 58. At step 244, client proxy 32 compresses second request 40, including generating a second request dictionary 150 and a second compressed request 152 based on second request 140. Second request dictionary 150 is generated based on both second request 140 and first request dictionary 50, as discussed above with reference to FIG. 2. At step 246, second request dictionary 150 is stored in client dictionary database 34 for future reference. Second request dictionary 150 may be combined with, or stored separately from, first request dictionary 50.

At step 248, second compressed request 152 is further compressed, such as using a ZIP™ compression technique, for example. At step 250, second request dictionary 150, second compressed request 152, client application ID 46 and web application ID 48 are communicated toward web application 24 along path 60 via wireless link 16. Second request dictionary 150 and second compressed request 152 are received by base station 26 and forwarded to, or intercepted by, proxy server 20.

At step 252, proxy server 20 decompresses second compressed request 152 (or in other words, reconstructs second request 140) using second request dictionary 150 and/or first request dictionary 50. In some situations, both second request dictionary 150 and first request dictionary 50 are used in reconstructing second request 140. At step 254, second request dictionary 150 is stored in server dictionary database 28 for future reference. Second request dictionary 150 may be combined with, or stored separately from, first request dictionary 50.

At step 256, the reconstructed second request 140 is communicated along path 62 via communications network 22 toward web application 24. The web service server 18 that hosts web application 24 receives and forwards second request 40 to web application 24. At step 258, web application 24 processes second request 140 and generates a second response 170. Web application 24 also determines web application ID 76 and client application ID 78 associated with second response 170.

At step 260, second response 170, web application ID 76 and client application ID 78 are communicated along path 90 toward wireless device 14. Second response 170 is received, or intercepted, by proxy server 20. At step 262, proxy server 20 compresses second response 170, including generating a second response dictionary 180 and a second compressed response 182 based on second response 170. Second response dictionary 180 is generated based on both second response 170 and first response dictionary 80, as discussed above with reference to FIG. 2. At step 264, second response dictionary 180 is stored in server dictionary database 28 for future reference. Second response dictionary 180 may be combined with, or stored separately from, first response dictionary 80.

At step 266, second compressed response 182 is further compressed, such as using a ZIP™ compression technique, for example. At step 268, second response dictionary 180, second compressed response 182, web application ID 76 and client application ID 78 are communicated toward wireless device 14 via base station 26 and wireless link 16, along path 92. Second response dictionary 180 and second compressed response 182 are received by wireless device 14 and forwarded to, or intercepted by, client proxy 32.

At step 270, client proxy 32 decompresses second compressed response 182 (or in other words, reconstructs second response 170) using second response dictionary 180 and/or first response dictionary 80. In some situations, both second response dictionary 180 and first response dictionary 80 are used in reconstructing second response 170. At step 272, second response dictionary 180 is stored in client dictionary database 34 for future reference. Second response dictionary 180 may be combined with, or stored separately from, first response dictionary 80.

At step 274, the reconstructed second response 170 is communicated along path 94, toward client application 30. Second response 170 is received by client application 30, which may display or otherwise present at least a portion of second response 170 to the user of wireless 14.

Although an embodiment of the invention and its advantages are described in detail, a person skilled in the art could make various alterations, additions, and omissions without departing from the spirit and scope of the present invention as defined by the appended claims.

What is claimed is:

1. A method of wireless communication, comprising:
receiving a first request;
generating a first compressed request and a first request dictionary based on the first request;
communicating the first compressed request and the first request dictionary via a wireless link toward an application operable to respond to the first request;
receiving a second request;
generating a second compressed request and a second request dictionary based on the second request and the first request dictionary; and
communicating the second compressed request and the second request dictionary toward the application via the wireless link.

2. The method of claim 1, further comprising:
storing the generated first request dictionary; and
storing the generated second request dictionary.

3. The method of claim 1, wherein:
the first request comprises a set of first request labels and a set of first request data items;
the first request dictionary comprises a set of first request dictionary entries, each first request dictionary entry associating a key from a set of first request keys with one of the first request labels; and
the first compressed request comprises the set of first request data items and, for each of the first request labels in the first request, the associated first request key.

4. The method of claim 1, wherein:
the first and second requests are requests for web services; and
the application is operable to provide the requested web services.

5. The method of claim 1, wherein the first and second requests comprise SOAP requests.

6. The method of claim 1, wherein receiving the first and second requests comprises receiving the first and second requests from an application associated with a wireless device at a proxy associated with the wireless device.

7. The method of claim 1, further comprising further compressing the first compressed request prior to communicating the first compressed request toward the application.

8. The method of claim 1, wherein:
the first request dictionary comprises a set of first request dictionary entries;
the second request dictionary comprises a set of second request dictionary entries;
generating the second request dictionary based on the second request and the first request dictionary comprises, for each of the second request dictionary entries:
determining whether the first request dictionary includes a first request dictionary entry corresponding with the second request dictionary entry; and
if it is determined that the first request dictionary includes a first request dictionary entry corresponding with the second request dictionary entry, excluding the second request dictionary entry from the second request dictionary.

9. The method of claim 1, wherein:
the first request comprises a set of first request labels and a set of first request data items;
the second request comprises a set of second request labels and a set of second data items;
the first request dictionary comprises a set of first request dictionary entries, each first request dictionary entry associating a key from a set of first request keys with one of the first request labels;
the second request dictionary comprises a set of second request dictionary entries, each second request dictionary entry associating a key from a set of second request keys with one of the second request labels;
the first compressed request comprises the set of first request data items and, for each of the first request labels in the first request, the associated first request key; and
the second compressed request comprises the set of second request data items and, for each of the second request labels in the second request, the associated second request key.

10. The method of claim 9, wherein generating the second request dictionary based on the second request and the first request dictionary comprises, for each of the second request labels in the second request:
determining whether the second request label is included within the first request dictionary; and
if the second request label is not included within the first request dictionary, generating a second request dictionary entry associating the second request label with one of the second request keys.

11. The method of claim 9, wherein generating the second request dictionary based on the second request and the first request dictionary comprises, for each second request dictionary entry:
determining whether the second request label associated with the second request dictionary entry is included within the first request dictionary; and
if the second request label is included within the first request dictionary, excluding the second request dictionary entry from the second request dictionary.

12. The method of claim 1, further comprising:
receiving via the wireless link a first response dictionary and a first compressed response, the first compressed response comprising a compressed form of a first response to the first request;
storing the first response dictionary; and
constructing the first response based on the first compressed response and the first response dictionary.

13. The method of claim 12, further comprising:
receiving via the wireless link a second response dictionary and a second compressed response, the second compressed response comprising a compressed form of a second response to the second request;
storing the second response dictionary; and
constructing the second response based on the second compressed response, the first response dictionary and the second response dictionary.

14. A method of wireless communication, comprising:
receiving from a requesting entity via a wireless link a first compressed request and a first request dictionary, the first compressed request comprising a compressed form of a first request;
constructing the first request based on the first compressed request and the first request dictionary;
communicating the constructed first request toward an application operable to respond to the first request;
receiving from the requesting entity via a wireless link a second compressed request and a second request dictionary, the second compressed request comprising a compressed form of a second request;
constructing the second request based on the second compressed request, the first request dictionary, and the second request dictionary;
communicating the constructed first request toward the application.

15. The method of claim 14, further comprising:
storing the first request dictionary; and
storing the second request dictionary.

16. The method of claim 14, wherein:
the first and second requests are requests for web services; and
the application is operable to provide the requested web services.

17. The method of claim 14, wherein the first and second requests comprise SOAP requests.

18. The method of claim 14, wherein the first and second requests are received from a wireless device.

19. The method of claim 14, further comprising:
receiving from the application a first response to the first request;
generating a first compressed response and a first response dictionary based on the first response; and
communicating the first compressed response and the first response dictionary toward the requesting entity via the wireless link.

20. The method of claim 19, wherein:
the first response comprises a set of first response labels and a set of first response data items;
the first response dictionary comprises a set of first response dictionary entries, each first response dictionary entry associating a key from a set of first response keys with one of the first response labels; and
the first compressed response comprises the set of first response data items and, for each of the first response labels in the first response, the associated first response key.

21. The method of claim 14, further comprising:
receiving from the application a first response to the first request;
generating a first compressed response and a first response dictionary based on the first response;
communicating the first compressed response and the first response dictionary toward the requesting entity via the wireless link;
receiving from the application a second response to the second request;
generating a second compressed response and a second response dictionary based on the second response and the first response dictionary; and
communicating the second compressed response and the second response dictionary toward the requesting entity via the wireless link.

22. The method of claim 21, wherein:
the first response dictionary comprises a set of first response dictionary entries;
the second response dictionary comprises a set of second response dictionary entries; and
generating the second response dictionary based on the second response and the first response dictionary comprises, for each of the second response dictionary entries:
determining whether the first response dictionary includes a first response dictionary entry corresponding with the second response dictionary entry; and
if it is determined that the first response dictionary includes a first response dictionary entry corresponding with the second response dictionary entry, excluding the second response dictionary entry from the second response dictionary.

23. The method of claim 21, wherein:
the first response comprises a set of first response labels and a set of first response data items;
the second response comprises a set of second response labels and a set of second data items;
the first response dictionary comprises a set of first response dictionary entries, each first response dictionary entry associating a key from a set of first response keys with one of the first response labels;
the second response dictionary comprises a set of second response dictionary entries, each second response dictionary entry associating a key from a set of second response keys with one of the second response labels;
the first compressed response comprises the set of first response data items and, for each of the first response labels in the first response, the associated first response key; and
the second compressed response comprises the set of second response data items and, for each of the second response labels in the second response, the associated second response key.

24. The method of claim 23, wherein generating the second response dictionary based on the second response and the first response dictionary comprises, for each of the second response labels in the second response:
determining whether the second response label is included within the first response dictionary; and
if the second response label is not included within the first response dictionary, generating a second response dictionary entry associating the second response label with one of the second response keys.

25. The method of claim 23, wherein generating the second response dictionary based on the second response and the first response dictionary comprises, for each second response dictionary entry:
determining whether the second response label associated with the second response dictionary entry is included within the first response dictionary; and
if the second response label is included within the first response dictionary, excluding the second response dictionary entry from the second response dictionary.

26. A system for wireless communications, the system operable to:
receive a first request;
generate a first compressed request and a first request dictionary based on the first request;
communicate the first compressed request and the first request dictionary via a wireless link toward an application operable to respond to the first request;
receive a second request;
generate a second compressed request and a second request dictionary based on the second request and the first request dictionary; and
communicate the second compressed request and the second request dictionary toward the application via the wireless link.

27. The system of claim 26, further operable to:
store the generated first request dictionary; and
store the generated second request dictionary.

28. The system of claim 26, wherein:
the first request comprises a set of first request labels and a set of first request data items;
the first request dictionary comprises a set of first request dictionary entries, each first request dictionary entry associate a key from a set of first request keys with one of the first request labels; and
the first compressed request comprises the set of first request data items and, for each of the first request labels in the first request, the associated first request key.

29. The system of claim 26, wherein:
the first and second requests are requests for web services; and
the application is operable to provide the requested web services.

30. The system of claim 26, wherein the first and second requests comprise SOAP requests.

31. The system of claim 26, wherein receiving the first and second requests comprises receiving the first and second requests from an application associated with a wireless device at a proxy associated with the wireless device.

32. The system of claim 26, further operable to further compress the first compressed request prior to the first compressed request being communicated toward the application.

33. The system of claim 26, wherein:
the first request dictionary comprises a set of first request dictionary entries;
the second request dictionary comprises a set of second request dictionary entries;
generating the second request dictionary based on the second request and the first request dictionary comprises, for each of the second request dictionary entries:
determining whether the first request dictionary includes a first request dictionary entry corresponding with the second request dictionary entry; and
if it is determined that the first request dictionary includes a first request dictionary entry corresponding with the second request dictionary entry, excluding the second request dictionary entry from the second request dictionary.

34. The system of claim 26, wherein:
the first request comprises a set of first request labels and a set of first request data items;
the second request comprises a set of second response labels and a set of second data items;
the first request dictionary comprises a set of first request dictionary entries, each first request dictionary entry associate a key from a set of first request keys with one of the first request labels;
the second request dictionary comprises a set of second request dictionary entries, each second request dictionary entry associate a key from a set of second request keys with one of the second request labels;
the first compressed request comprises the set of first request data items and, for each of the first request labels in the first request, the associated first request key; and
the second compressed request comprises the set of second request data items and, for each of the second request labels in the second request, the associated second request key.

35. The system of claim 34, wherein generating the second request dictionary based on the second request and the first request dictionary comprises, for each of the second request labels in the second request:
determining whether the second request label is included within the first request dictionary; and
if the second request label is not included within the first request dictionary, generating a second request dictionary entry associate the second request label with one of the second request keys.

36. The system of claim 34, wherein generating the second request dictionary based on the second request and the first request dictionary comprises, for each second request dictionary entry:
determining whether the second request label associated with the second request dictionary entry is included within the first request dictionary; and
if the second request label is included within the first request dictionary, excluding the second request dictionary entry from the second request dictionary.

37. The system of claim 26, further operable to:
receive via the wireless link a first response dictionary and a first compressed response, the first compressed response comprising a compressed form of a first response to the first request;
store the first response dictionary; and
construct the first response based on the first compressed response and the first response dictionary.

38. The system of claim 37, further operable to:
receive via the wireless link a second response dictionary and a second compressed response, the second compressed response comprising a compressed form of a second response to the second request;
store the second response dictionary; and
construct the second response based on the second compressed response, the first response dictionary and the second response dictionary.

39. A system for wireless communication, the system operable to:
receive from a requesting entity via a wireless link a first compressed request and a first request dictionary, the first compressed request comprising a compressed form of a first request;
construct the first request based on the first compressed request and the first request dictionary;
communicate the constructed first request toward an application operable to respond to the first request;
receive from the requesting entity via a wireless link a second compressed request and a second request dictionary, the second compressed request comprising a compressed form of a second request;
construct the second request based on the second compressed request, the first request dictionary, and the second request dictionary;
communicate the constructed first request toward the application.

40. The system of claim 39, further operable to:
store the first request dictionary; and
store the second request dictionary.

41. The system of claim 39, wherein:
the first and second requests are requests for web services; and
the application is operable to provide the requested web services.

42. The system of claim 39, wherein the first and second requests comprise SOAP requests.

43. The system of claim 39, wherein the first and second requests are received from a wireless device.

44. The system of claim 39, further operable to:
receive from the application a first response to the first request;
generate a first compressed response and a first response dictionary based on the first response; and
communicate the first compressed response and the first response dictionary toward the requesting entity via the wireless link.

45. The system of claim 44, wherein:
the first response comprises a set of first response labels and a set of first response data items;
the first response dictionary comprises a set of first response dictionary entries, each first response dictionary entry associate a key from a set of first response keys with one of the first response labels; and
the first compressed response comprises the set of first response data items and, for each of the first response labels in the first response, the associated first response key.

46. The system of claim 39, further operable to:
receive from the application a first response to the first request;
generate a first compressed response and a first response dictionary based on the first response;
communicate the first compressed response and the first response dictionary toward the requesting entity via the wireless link;
receive from the application a second response to the second request;
generate a second compressed response and a second response dictionary based on the second response and the first response dictionary; and
communicate the second compressed response and the second response dictionary toward the requesting entity via the wireless link.

47. The system of claim 46, wherein:
the first response dictionary comprises a set of first response dictionary entries;
the second response dictionary comprises a set of second response dictionary entries; and
generating the second response dictionary based on the second response and the first response dictionary comprises, for each of the second response dictionary entries:
determining whether the first response dictionary includes a first response dictionary entry corresponding with the second response dictionary entry; and
if it is determined that the first response dictionary includes a first response dictionary entry corresponding with the second response dictionary entry, excluding the second response dictionary entry from the second response dictionary.

48. The system of claim 46, wherein:
the first response comprises a set of first response labels and a set of first response data items;
the second response comprises a set of second response labels and a set of second data items;
the first response dictionary comprises a set of first response dictionary entries, each first response dictionary entry associate a key from a set of first response keys with one of the first response labels;
the second response dictionary comprises a set of second response dictionary entries, each second response dictionary entry associate a key from a set of second response keys with one of the second response labels;
the first compressed response comprises the set of first response data items and, for each of the first response labels in the first response, the associated first response key; and
the second compressed response comprises the set of second response data items and, for each of the second response labels in the second response, the associated second response key.

49. The system of claim 48, wherein generating the second response dictionary based on the second response and the first response dictionary comprises, for each of the second response labels in the second response:
determining whether the second response label is included within the first response dictionary; and
if the second response label is not included within the first response dictionary, generating a second response dictionary entry associate the second response label with one of the second response keys.

50. The system of claim 48, wherein generating the second response dictionary based on the second response and the first response dictionary comprises, for each second response dictionary entry:
determining whether the second response label associated with the second response dictionary entry is included within the first response dictionary; and
if the second response label is included within the first response dictionary, excluding the second response dictionary entry from the second response dictionary.
